(19) United States
(12) Patent Application Publication
(10) Pub. No.: US 2004/0054505 A1
(43) Pub. Date: Mar. 18, 2004

(54) Hierarchial neural network intrusion detector

(76) Inventor: Susan C. Lee, Columbia, MD (US)

Correspondence Address: Benjamin Y Roca Office of Patent Counsel, The Johns Hopkins University, Applied Phsyics Laboratory, 11100 Johns Hopkins Road, Laurel, MD, 20723-6099, US

(21) Appl. No.: 10/433,713

(22) PCT Filed: Dec. 12, 2001
(86) PCT No.: PCT/US01/47828

(51) Int. Cl. G06F 15/00

(52) U.S. Cl. 702/186

(57) ABSTRACT

A hierarchical neural network for monitoring network functions and that functions as a true anomaly detector is disclosed. Detection of an anomaly is achieved by monitoring selected areas of network behavior, such as protocols, that are predictable in advance. Combining outputs of neural networks within the hierarchical network yields satisfactory anomaly detection.

### CROSS-REFERENCE TO RELATED APPLICATIONS

The present invention is related to, and claims the benefit of, U.S. Provisional Patent Application No. 60/255,164 filed Dec. 13, 2000.

### BACKGROUND OF THE INVENTION

The present invention relates to detection of intrusion into a computer system such as a computer network. While many commercial intrusion detection systems (IDS) are deployed, the protection they afford is modest. The original concept of intrusion detection as described in D. E. Denning, “An Intrusion Detection Model,” IEEE Transactions on Software Engineering, Vol. 13-2, p. 222, February 1987, was an anomaly detector. Early IDS functioned based on this concept to detect an anomaly in system operation. For example, systems like the Intrusion Detection Expert System (IDES) disclosed in H. Javitz and A. Valdes, “The SR1 IDES Statistical Anomaly Detector,” Proceeding of the Symposium on Research in Security and Privacy, May 1991, pp. 316-326, and the Next-generation IDES (NIDES) disclosed in D. Anderson, T. Friviold, and A. Valdes, “Next Generation Intrusion Detection Expert System (NIDES): A Summary,” SR1 International, Menlo Park, Calif., Tech. Rep. SR1-CSL-95-07, May 1995, were built around the concept of a statistical anomaly detector. Two difficulties, one practical and the other theoretical confounded these early systems. The practical difficulty is that nominal usage has high variability and changes over time. To meet this challenge, systems had a fairly loose threshold for tolerance of anomalous behavior, and were designed to learn new nominal statistics as they worked. This solution to the practical limitations of statistical anomaly detectors led to the theoretical difficulties: intruders could work below the threshold of tolerance and “teach” the systems to recognize increasingly abnormal patterns as normal.

To meet these difficulties, a new paradigm for intrusion detection was introduced: signature recognition. Attempts have been made to create systems that recognize the signature of “normal” accesses to a computer system. The basis for such systems is that by recognizing “normal” accesses, then attacks, known or novel can be detected because they are not “normal” accesses. But, such systems are often confounded by the extreme variability of nominal behavior. In addition, various data sources and types of pattern recognition techniques are used to separate attacks signals from normal usage noise. But, the performance of these systems is limited by the signature database they work from. Many known attacks can be easily modified to present many different signatures as described by T. H. Ptacek and T. N. Newsham, “Insertion, Evasion, and Denial of Service: Eluding Network Intrusion Detection,” Secure Networks, Inc, Tech. Rep. 1998. If all variations are not in the database, even known attacks may be missed. Completely novel attacks, by definition, cannot be present in the database, and will nearly always be missed.

A number of IDS involve “training” of a neural network detectors—that is, a process by which the inputs with known contents are applied to the neural network IDS, and a feedback mechanism is used to adjust the parameters of the IDS until the actual outputs of the IDS match desired outputs for each input. If such an IDS is to detect novel attacks, it should be trained to distinguish the possible nominal inputs from possible inputs. In addition, obtaining training data with known content is difficult. It can be very time consuming to collect real data to use in training, especially if the training data is to represent a full range of nominal conditions. It is difficult, if not impossible, to collect real data representative of all anomalous conditions. If the input representing “anomalous” behavior includes know attacks, the IDS will learn to recognize those particular signatures as bad, but may not recognize other, novel attack signatures.

While there are other hierarchical neural network based IDS, they use the hierarchy to aggregate the outputs of monolithic IDS at a central location. They do not use a hierarchy as a basic detector in the manner disclosed herein. They also use the hierarchy to consolidate information for an operator, not to strengthen detection certainty or to reduce false alarms as does the technology disclosed herein.

Many characteristics of networking or computing can be completely specified in advance. Examples of these are network protocols or an operating system's “user-to-root” transition. A substantial number of attacks distort these specifiable characteristics. For this class of attack, the technology disclosed herein generates training data so that an IDS can be trained to detect novel attacks, not simply those known at the time of training.

### SUMMARY OF THE INVENTION

It is an object of the present invention to provide a hierarchical neural-network intrusion detector.

It is another object of the present invention to provide a hierarchical neural-network intrusion detector that detects novel intrusions.

It is a further object of the present invention to provide a hierarchical neural-network intrusion detector that reduces the number of false alarms.

It is still another object of the present invention to provide a hierarchical neural-network intrusion detector that has a better probability of detection with lower false alarm rate.

To achieve the above and other objects, the present invention provides a hierarchical neural network for monitoring network functions, comprising: a set of primary neural networks operatively connectable to receive inputs associated with respective ones of the network functions, each of the primary neural networks having an output; and a first tier of neural networks operatively connected to combine selected outputs of the primary neural networks.

### BRIEF DESCRIPTION OF THE DRAWINGS

FIG. 1 is a schematic diagram of a lower portion of an exemplary hierarchical neural network in accordance with the present invention.

FIG. 2 is a schematic diagram of an upper portion of an exemplary hierarchical neural network in accordance with the present invention.

FIG. 3 is a schematic diagram of an exemplary hierarchical neural network in accordance with the present invention.

FIGS. 4(a)-(f) graphically illustrate the output of an exemplary hierarchical neural network in accordance with the present invention.

FIG. 5 graphically illustrates the performance of six different arrangements of a hierarchy of neural networks.

FIG. 6 graphically illustrates a vector map displaying converted n-dimensional vectors in accordance with the present invention for the fast scan, SYN Flood, and surge login events.

FIG. 7 graphically illustrates converted n-dimensional vectors in accordance with the present invention for the stealthy scan on an expanded scale.

### DETAILED DESCRIPTION OF THE PREFERRED EMBODIMENTS

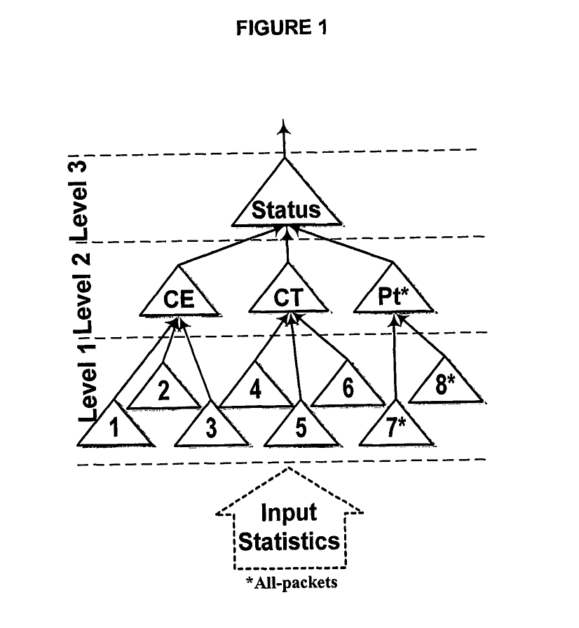

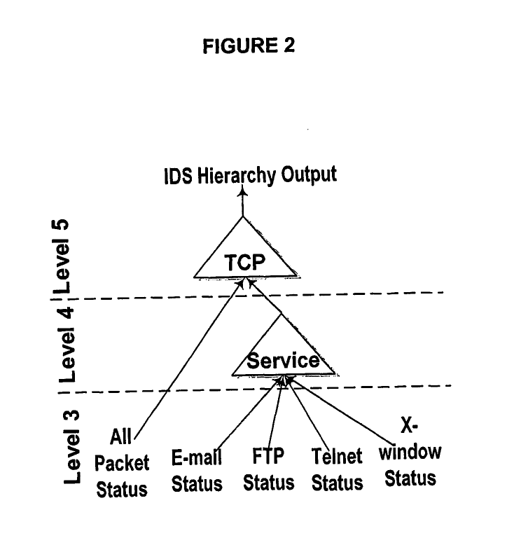

FIGS. 1 and 2 are schematic diagrams of portions of an exemplary hierarchical, back propagation neural network to which the present invention can be applied. The use of back propagation in neural networks is well known as discussed in C. M. Bishop, Neutral Networks for Pattern Recognition. New York: Oxford University Press, 1995. In the exemplary embodiment described herein, the training data was created without reference to network data, but obtained from assertions about network behavior that are embodied in network protocols, such as the TCP protocol. The IDS is evaluated using test data produced by a network simulation. Use of a simulation to produce test data has good and bad features. The model is limited in its fidelity; however, the user and attacker behavior can be controlled (within limits) to produce challenging test cases.

The exemplary IDS focuses on the TCP protocol. Training of a neural network in accordance with the present invention is not limited to any particular protocol. TCP was selected as an exemplary protocol because it has a rich repertoire of well-defined behaviors that can be monitored by the exemplary IDS. The three-way connection establishment handshake, the connection termination handshake, packet acknowledgement, sequence number matching, source and destination port designation, and flag-use all follow pre-defined patterns. In the exemplary IDS described herein, and to which training in accordance with the present invention can be applied, is assumed to be a host-based system protecting a network server. Although the exemplary IDS looked only at TCP network data, it is ‘host-based’ in the sense that the IDS data are packets received by or sent from the server itself; that is, it did not see all network TCP traffic.

Not all of the richness of the TCP protocol could be exploited in the exemplary setup. For example, packet formation (particularly, flag use) would be a very productive area to monitor, but ill-formed packets could not be produced by the network simulation, therefore the exemplary IDS did not monitor packet formation. The portions of the TCP protocol that could be monitored and tested in the exemplary setup are connection establishment, connection termination and port use.

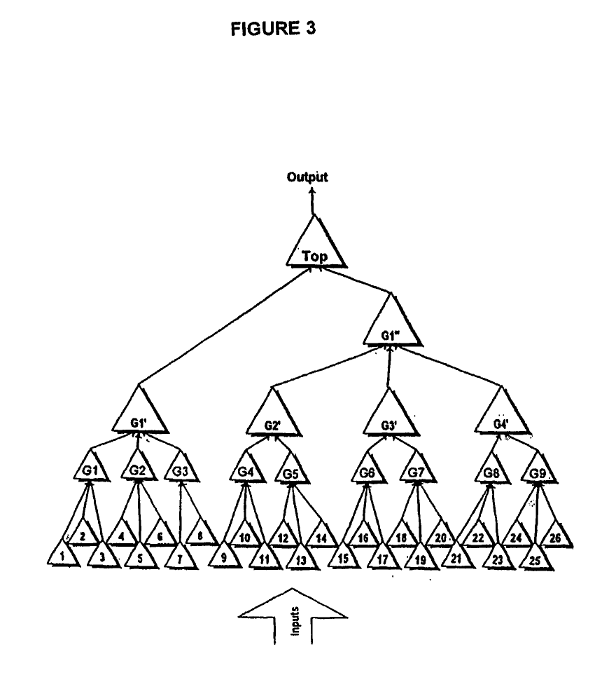

FIG. 3 is a schematic diagram of an exemplary hierarchical neural network in accordance with the present invention. In FIG. 3, reference numerals 1-26 represent primary neural networks. In accordance with the exemplary embodiment discussed herein, these primary neural networks receive desired inputs from the system being monitored. Reference numerals G1-G9 represent first tier grouping; reference numerals G11-G4′ represent second tier grouping; and reference numeral G11″ represent a third tier grouping. The last tier in FIG. 3 is designated TOP.

A hierarchical neural network in accordance with the present invention can include any number of primary neural networks, 1-n. Each primary neural network monitors some small aspect of the network behavior. In the exemplary embodiment discussed herein it is important that the primary neural networks, monitor, e.g., receive inputs representing a single input, behavior, or networking aspect. The outputs of the primary neural networks, are combined into groups that form the inputs to any number of secondary neural networks, G1-Gn. The formation of the groups may be based on any criteria appropriate to the function, behavior, or aspect monitored by the associated primary neural networks. The grouping of outputs at one level to form the inputs to an arbitrary number of neural networks at a higher level nay be repeated an arbitrary number of times, until a single output indicating the intrusion status of the monitored network is achieved. FIG. 3 shows four such groupings; at the first tier, the second tier, at the third tier, and at the last tier.

The neural networks at the first tier or secondary level and above are trained to combine the inputs using logical combinational functions. In the exemplary embodiment discussed herein, the functions are defined as follows. A “Soft OR” provides a “1” output if it receives a single strong input, or if it receives many moderate inputs. The “Soft OR” provides a “0” output if there are only weak inputs. A “Soft AND” provides a “1” output if the average of inputs is greater than an arbitrary threshold. The “Soft AND” provides a “0” output if the average of the inputs are below the same threshold. Those skilled in the art will recognize that other combinatorial functions may be used, and that the functional characteristics of the “Soft OR” and “Soft AND” may be modified from that of the exemplary embodiment if desired. It will also be recognized that the selection of OR and AND, or any other combinational function, for use in a particular neural network at the secondary level or higher is dependent on the allowable false alarm rate versus the required probability of detection. Any combination of combinational functions can be used until the desired result is achieved.

A hierarchical structure such as disclosed in FIG. 3 breaks the task of intrusion detection into small focused components. It uses the neural networks to monitor each primary element of the intrusion detection task, that is, to monitor each small primary element of the intrusion task. The exemplary structure of FIG. 3 provides a recombination of the small focused components into a comprehensive picture of intrusion by using an arbitrary hierarchical architecture of neural networks with fixed combinational elements above the first level.

Table 1 gives the very simple set of assertions utilized by the exemplary IDS. The assertions in Table 1 were applied to the packets associated with each individual service, and to all TCP packets aggregated globally. No assumptions are made about use statistics; the assertions in Table 1 hold regardless

TABLE 1
Lowest-Level NN Definitions

| NN # | Assertion(s)¹ |
|---|---|
| 1 | #new connections established = # SYN-ACK sent + ΔQueue Size |
| 2 | #SYN-ACK sent = #SYN received − #SYN dropped |
| 3 | ΔQueue Size = #SYN received − |
| | (#new connections + #queue entries timed out) |
| 4 | #FIN sent = # FIN received |
| 5 | #FIN pairs, #Reset sent, #Reset received <= # connections open |
| 6 | #connections closed = #FIN pairs + #Reset sent + #Reset received |
| 7² | # rec'd data packet source sockets = # sent packet dest. sockets |
| | # rec'd packet dest. ports = # sent packet source ports |
| 8² | # rec'd data packet source sockets <= # open connections |
| | # sent packet dest. sockets <= # open connections |
| ¹ In this server model, all SYN packets are received, all SYN-ACKs are sent. | |
| ² Used only in the all-TCP packets monitor | |

of the volume of traffic, packet size distribution, inter-arrival rates, login rates, etc. The assertions do not even include knowledge about the number of and ports for services allowed on the monitored server, although this could well be doable for real systems. The truth of the assertions in Table 1, and more, could be tested precisely by a program that maintained state on every packet sent and received. Writing such a program would be akin to rewriting the TCP network software. If a re-write of TCP is contemplated, it would be more productive simply to put in the error and bounds checking that would prevent exploitation of the protocol for attacks. Rather than maintaining state on

TABLE 2
Input Statistics Definition

# SYNs received
# SYNs dropped
# SYN-ACKs sent
# of new connections made
# of queued SYNs at end of the last window (T-30 sec)
# of queued SYNs at end of this window (T)
# queued SYNs timed-out
Max # of connections open
# FIN-ACKs sent
# FIN-ACKs received
# Resets sent
# Resets received
# of connections closed
# source sockets for received.data packets
# destination sockets for sent packets
# destination ports for received.packets
# source ports for sent packets

every packet and connection, the experiment tested whether or not the assertions would hold well enough over aggregated statistics to detect anomalies. The packet and TCP connection statistics utilized in the exemplary data discussed herein were generated over 30 second windows. The 30 second windows were overlapped by 20 seconds, yielding an IDS input every 10 seconds. The input statistics are given in Table 2.

The test data included baseline (nominal use) data, and four distinct variations from the baseline. One is an extreme variant of normal use, where multiple users try to use Telnet essentially simultaneously. Three attacks were used: a SYN Flood, a fast SYN port scan, and a “stealthy” SYN port scan. The first three—the high-volume normal use, the SYN Flood and the fast port scan—all cause large numbers of SYN packets to arrive at the server in a short period of time. The “stealthy scan” variant tested the system's threshold of detection.

FIG. 1 is a schematic diagram of a lower portion of an exemplary hierarchical neural network (NN) to which the present invention can be applied. Packet and queue statistics are used as input to the lowest-level NNs monitoring the nominal behaviors described in Table 1. The outputs from the Level 1 NNs are combined at Level 2 into connection establishment (CE), connection termination (CT) and port use (Pt, for all-packets only) monitors. Finally, the outputs of the Level 2 NNs are combined at Level 3 into a single status. The hierarchy shown in FIG. 1 was replicated to monitor the individual status of the TCP services and “all-packets” status. FIG. 2 is a schematic diagram of an upper portion of an exemplary hierarchical neural network to which the present invention can be applied. This figure shows how each of these status monitors was combined to yield a single TCP status.

While the NNs at the lowest level of the hierarchy are trained to monitor the assertions listed in Table 1, the NNs at higher levels are intended to combine lower-level results in a way that enhances detection while suppressing false alarms. Two combinational operators, OR and AND, were chosen for the higher level NNs. A soft OR function was implemented that passed high-valued inputs from even a single NN, enhanced low-valued inputs from more than one contributing NN, and tended to suppress single, low-valued inputs. A soft AND function was implemented that enhanced inputs when the average value from all contributing NNs exceeded some threshold, but suppressed inputs whose average value was low.

For the NNs at Levels 2 and 3, both an OR and an AND NN was tried. This resulted in the four arrangements shown in Table 3. At levels 4 and 5, only OR NNs were

TABLE 3
Hierarchy Combinational Variations

| | Level 3 | |
|---|---|---|
| | AND | Level 3 OR |
| Level 2 | AND-AND | AND-OR |
| AND | | |
| Level 2 OR | OR-AND | OR-OR |

used. This seemed logical, since an attack can be directed at a single service (the SYN Flood attack in the test data for this experiment was directed at Telnet only) and some attacks (like port scan) are only visible to the “all packet” NNs. Using an AND function to combine the status outputs would tend to wash out these attacks.

In addition to hierarchy variations described above, two contrasting hierarchies were tested. First, the NNs at Levels 1 and 2 were eliminated, and a single “flat” NN at Level 3 categorized the input statistics. This arrangement tested the value of the hierarchy. Second, the arbitrary hierarchy shown in FIGS. 1 and 2 was replaced with a hierarchy carefully crafted to give the best performance on the test data. This arrangement demonstrates the built-in biases of the hierarchy.

A back propagation NN is initialized randomly and must undergo “supervised learning” before use as a detector. This requires knowledge of the desired output for each input vector. Often, obtaining training data with known content is difficult. Furthermore, if the input representing “anomalous” contains known attacks, the NN will learn to recognize those particular signatures as bad, but may not recognize other, novel attack signatures.

The NNs described herein were trained using data generated artificially, eliminating both problems. Input vectors to each NN comprise random numbers. Each input vector was tested against the assertion monitored by that particular NN. The desired output was set to “nominal” for all random vectors for which the assertion held; the desired output was set to “anomalous” for all other vectors. Because only a few nominal vectors are generated by this approach, the set of nominal inputs was augmented by selecting some elements of the input vector randomly, and then forcing the remaining elements to make the assertion true.

In general training data can be developed for each monitored characteristic having a specifiable property. For each of these properties, assertions are devised about the relationship(s) that hold among the measured network or computing parameters. Examples of such assertions are shown in Table 1. Then random numbers are generated to correspond to each of the measured parameters. Sets of randomly-generated “parameters” (corresponding to the multi-dimensional inputs to the IDS) are tested against the assertion(s) for the monitored characteristic. The desired output is set to “nominal” for all sets of random numbers for which the assertion holds; the desired output is set to “anomalous” for all other sets. In general, the percentage of random number sets for which the assertion holds is small. The percentage of nominal inputs can be augmented by selecting some of the parameters randomly, and then forcing the remaining parameters to make the assertion true. By generating a sufficient number of training inputs as described above, the space of nominal and anomalous inputs can be reasonably well-spanned. By generating a sufficient number of vectors (4000-6000 were used in experiment described herein), the n-dimensional space of nominal and anomalous input statistics can be reasonably well-spanned. The NN learns to distinguish the nominal pattern from any anomalous (attack) pattern.

Exemplary test data was generated by running a network simulation developed using Mil3's OPNET Modeler. OPNET is tool for event-driven modeling and simulation of communications networks, devices and protocols. The modeled network consisted of a server computer, client computers and an attacking computer connected via 10 Mbps Ethernet links and a hub. The server module was configured to provide email, FTP, telnet, and Xwindows services. In the example described herein, the attacking computer module was a standard client module modified to send out only SYN packets. Those packets can be addressed to a single port to simulate a SYN flood attack or they can be addressed to a range of ports for a SYN port scan. For baseline runs, the attacking computer was a non-participant in the network.

For the surge Telnet login case, the model was configured so that all but two of the clients began telnet sessions at the same time. This created a deluge of concurrent attempts to access the telnet service. The login rate this simulation produced was several hundred times higher than the baseline rate. At the start of the surge of logins, the server is overwhelmed and drops some SYN packets. The other two clients were used to provide consistent traffic levels on the other available services.

Five simulation runs of 37,550 (simulated) seconds were made. Each run contained baseline data plus four events—one “surge” in Telnet logins and the three attacks, Twenty-five different seed values were used for the baseline portions. The port scans were conducted at varying rates and over different numbers of ports to assess the effect of scan packet arrival rate on the IDS'

TABLE 4
Event Descriptions.

| Event | Characteristics |
|---|---|
| Surge Logins | 200-300 × base login rate |
| SYN Flood | 50 Syn's/sec until queue is full |
| Fast Port Scan | 50 ports/second, 20-1000 ports |
| Stealthy Port Scan | 0-6 scan packets per 30-s window |

ability to detect the scan. Table 4 describes the characteristics of the simulation runs.

The following summarizes the results of applying training data in accordance with the present invention to a back propagation hierarchical neural network

A. Anomaly Detection

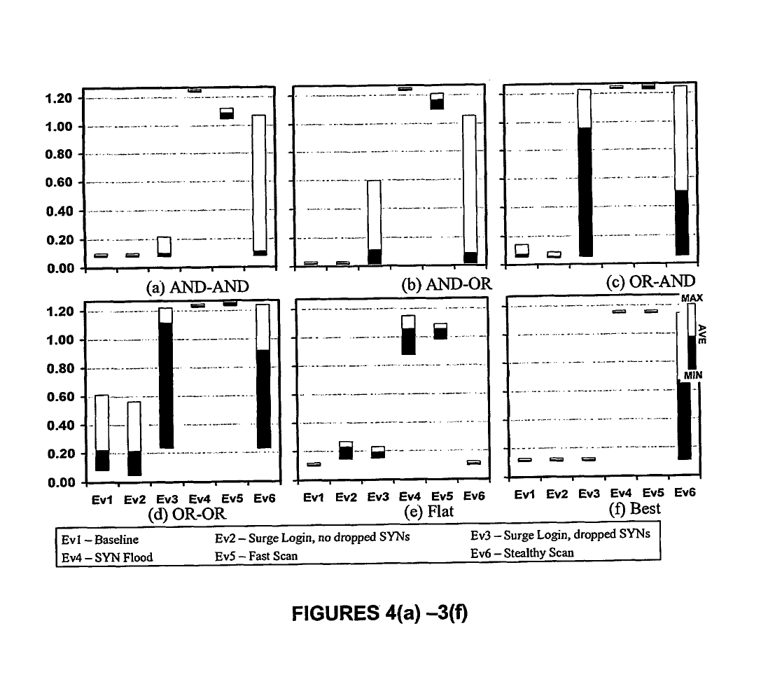

After training with the randomly generated data described above, each lower level NN in the hierarchy was presented with the network simulation data. FIG. 4 summarizes the performance of the six exemplary back propagation hierarchies over all five runs. To make these graphs, the maximum, minimum and average output of each hierarchy was calculated for the baseline, surge logins, and the three attacks. The surge login event was further broken down into two parts: a “nominal” part when the server could handle the incoming login requests, and an “off-nominal” part when the server dropped SYN packets. The length of the bars in FIG. 4 shows the range of outputs, while the color changes at the average output.

The first thing to note is that for all hierarchies, the output for nominal inputs—baseline and surge logins when no SYNs are dropped—are virtually identical. This is a key result, since true network activity does not follow the normal distributions used in the OPNET network model; instead, it appears to follow heavy-tailed distributions where extreme variability in the network activity is expected. True network data might be expected to have more, and more extreme, variability than was seen in the simulation output baseline. The surge login results suggest that the IDS would tolerate these usage swings without false alarms, so long as the server can keep up with the workload.

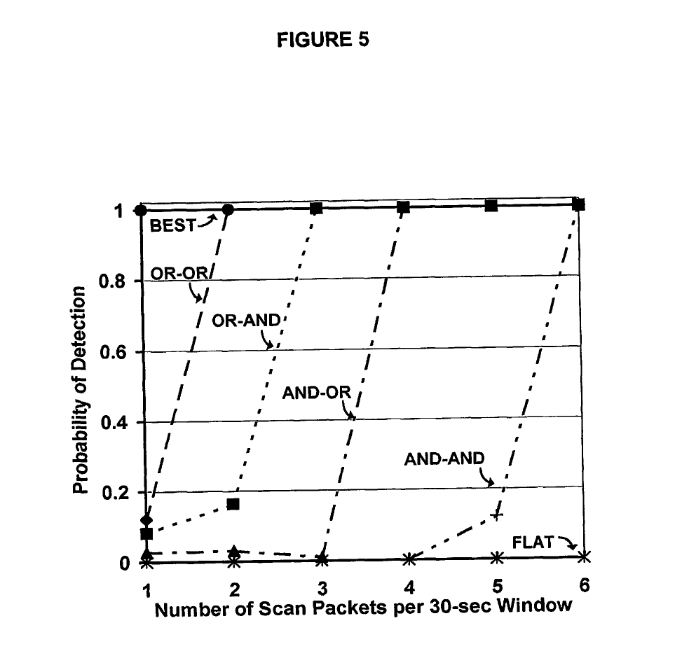

The second notable result is that the output for the SYN Flood and fast scan attacks are well separated from the nominal output. A threshold can be set for all hierarchies that results in 100% probability of detection (PD) for these attacks, with no false alarms (FA) from nominal data. All hierarchies excepting the “flat” one detected some part of the stealthy scan. The wide range of outputs for the stealthy scan reflects the fact that the scan packet rate was varied to test sensitivity. FIG. 5 shows the PD for the stealthy scan as a function of scan packet rate. For each hierarchy type, the detection threshold was set just above the maximum output for nominal inputs, so these are PD at zero FA.

Some of the hierarchies responded to the “off-nominal” surge login, that is, during the time when SYN packets were dropped. This result was not expected. Investigation showed that this FA arises mainly from a mis-formulation of the assertion embodied in NN #3. The change in the queue size depends not on the number of SYNs received, but rather on the number of SYNs processed; that is, on the number of SYNs received less the number dropped. The incorrectly-stated assertion is violated whenever SYN packets are dropped, yielding a strong response during this portion of the surge login. When AND combinational NNs are used at the Level 2, this response is suppressed; however, the OR combinational NNs at Level 2 pass this output unchanged to Level 3, and reinforce the weak response to the surge login on other Level 1 NNs. This illustrates the general effect of the AND and OR NNs. Using AND NNs, especially at Level 2, strongly suppressed noise, but also reduced sensitivity to the stealthy scan. Using OR NNs increased sensitivity at the expense of increased noise.

The “flat” hierarchy was unable to detect the stealthy scan at all. This result shows the sensitivity advantage of the deeper hierarchies. What is not evident from this graph is the difference in robustness between the hierarchy and flat IDS. The flat IDS made its determinations on the basis of just three inputs. A flat NN with only these inputs responds as well as the flat NN with all inputs; a flat NN without just one of these inputs will miss a detection or have a FA at the surge login. This contrasts with the original hierarchy, where the SYN Flood and the scans (fast and stealthy) are each recognized by several Level 1 NNs using different input statistics. This diversity should yield a more robust detector.

The output of the “best” hierarchy shows that the organization of the hierarchy has a strong effect. Instead of grouping the Level 1 NNs into CE, CT, and Pt groups, hindsight was used to establish three different groups: 1) all NN that responded to the surge login, 2) of the remaining NNs, the ones that respond to the stealthy scan, and 3) all the rest. This hierarchy performed as well as could possibly be desired. In fact, as shown in FIG. 5, a threshold could be established that resulted in 100% PD at 0% FA, even for scan packet rates of 1 or fewer scan packets per 30-second window. Unfortunately, to rearrange the hierarchy to enhance detection of particular attacks is tantamount to introducing a signature detector into the IDS. A parametric study could quantify the sensitivity of PD and FA to the hierarchy arrangement.

B. Anomaly Classification

There are two reasons to replace the upper-level back propagation NNs in the hierarchy with some alternative processing. First, the back propagation hierarchy gives a simple summary nominal/anomaly output, and information about the nature of the anomaly incorporated in the lower-level NNs is lost. Second, as demonstrated above, the hierarchy itself introduces an element of signature recognition into the IDS. To overcome these drawbacks, the NNs at Level 2 were eliminated completely, and the back propagation NNs at Levels 3-5 were replaced with detectors that sort the unique arrangements of inputs into anomaly categories.

The first candidate for these new detectors was a Kohonen Self-Organizing Map (SOM) as described in T. Kohonen, Self-Organizing Maps. New York: Springer-Verlag, 1995. The SOM provides a 2-D mapping of n-dimensional input data into unique clusters. The visualization prospects offered by a “map” of behavior are attractive, however, other properties of a SOM are less appealing in this context. First, a SOM works best when the space spanned by the n-dimensional input vectors is sparsely populated. The Level 1 NN output data had more variability than the SOM could usefully cluster. The SOM was nearly filled with points, and although a line could be drawn around an area where the nominal points seemed to fall, it offered no more insight than the back propagation hierarchy, at a higher computational cost. Second, the SOM only clusters data that is in its training set. The presentation of novel inputs after training produces unpredictable results.

Because the Level 1 NN output vectors appeared stable within an event type, and distinct between events, some means of mapping from the multi-dimensional output space to a 2-D display seemed possible. A simpler mapping technique was devised. An arbitrary vector was chosen for a reference; for this experiment, the reference vector was an average of the baseline hierarchy outputs. Then, for every input vector, the detector calculated the difference in length and angle from the reference vector. X-Y coordinates were generated from the length and angle computed from each input. The numeric values of the X-Y pairs themselves are meaningless, except to separate unlike events on a 2-D plot. These X-Y pairs were plotted like the X-Y pairs generated by the SOM. This is referred to as a “vector map”. While the vector map is not guaranteed to map all distinct anomalous vectors into separate places on the map, it worked well for the exemplary data.

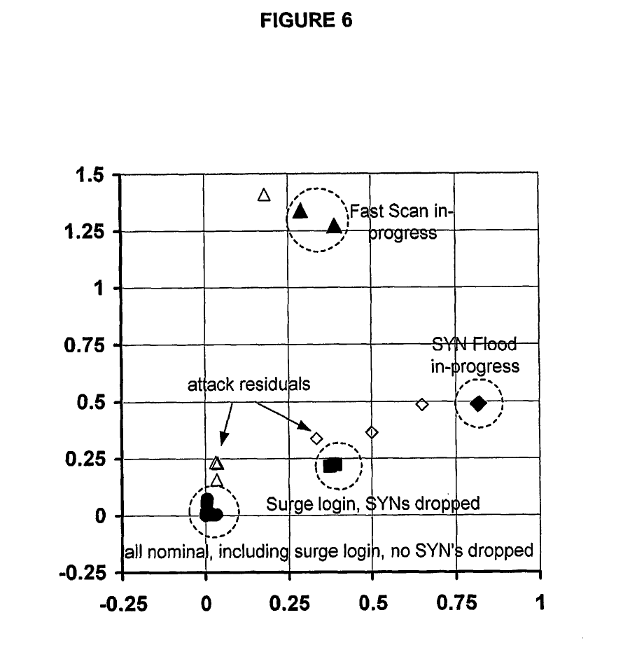

FIG. 6 shows a vector map for the baseline, surge login, SYN Flood and fast scan data from Run 1 (there is little run-to-run variation). Due to the reference vector choice, nominal points (baseline and nominal surge login) all cluster at 0,0. While the attack is on-going, the fast scan and SYN Flood points are well-separated from each other and from nominal. The off-nominal surge login points are distinct from nominal, but are also distinct from both the SYN Flood and fast port scan while the attacks are in progress. Using this technique, this event can be classified as an anomaly, but not a malicious attack.

Other scattered points identified with the true attacks actually occur after the attack is over, but while the residual effects are still felt. For example for a SYN Flood, after the spoofed SYN packets stop, the queue remains full for 180 seconds. During that time, extra SYN-ACKs are sent to attempt to complete the spoofed connection requests, and legitimate users attempt to login and fail. These anomalous events map to unique locations.

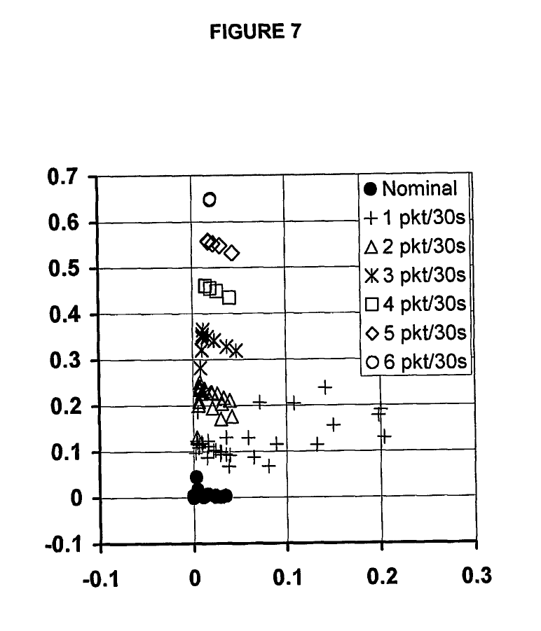

For clarity, FIG. 7 shows the vector map for the stealthy scan on an expanded scale. Distance from nominal increases with scan packet rate, however, even one scan packet per 30-second window maps to a location distinct from nominal. Thus over time, even a very stealthy scan, with packet intervals of minutes to hours, will eventually be detectable as an accumulation points on the map outside the nominal location.

Within the limitations of the exemplary setup, the experiment described herein shows that an IDS can be devised that truly responds to anomalies, not to signatures of known attacks. The exemplary IDS was 100% successful in detecting specific attacks, without a priori information on or training directed towards those attacks. Because of the training method used, it is expected that the IDS would detect any attack that perturbs the parameters visible to the exemplary IDS. To produce this result, the normal behavior must be specifiable in advance. Since network protocols can be formally specified, at least attacks that exploit flaws in protocol implementations should be detectable this way. In other experiments, the approach has been successfully applied to RFC1256 and IGMP as well as TCP.

Other well-defined procedures, such as obtaining root access, are also candidates for application of this technique. In recent research, formal specifications have been used to define test cases for complete fault coverage as described in P. Sinlia, and N. Suri, “Identification of Test Cases Using a Formal Approach,” in Proceedings of the 29th Annual International Symposium on Fault Tolerant Computing, Jun. 15-18, 1999. The exemplary IDS suggests that formal specifications may provide a means for creating intrusion detectors as well. The use of windowed statistics in the exemplary detector demonstrates that this approach does not require a stateful, packet-by-packet analysis of traffic for successful application.

The techniques demonstrated in this experiment appear to be resilient to variations in normal behavior that might confound another anomaly detector. They do not depend on use statistics, and traffic volume has little effect on the output. The hierarchical approach is shown to be more sensitive and more robust than a flat implementation. The hierarchy was able to detect more subtle attacks than a single detector using the same inputs. Further, it used more of the inputs in making its determination of detected anomalies.

While the lowest-level detectors in the system are not attack-signature based, the hierarchy itself introduces an element of signature-based detection. This undesirable feature can be overcome by replacing some of the NNs in the hierarchy with alternative detectors. A mapping technique called “vector mapping” was worked well in this role. A combination of back propagation NNs and vector maps was able to summarize overall TCP status while distinguishing among types of anomalies. Even very stealthy scans, with scan packets arriving at long intervals, could be detectable with this approach. The vector map technique is not limited to use with NN detectors, but might be used on other low-level IDS outputs.

1. A hierarchical neural network for monitoring network functions, comprising:
a set of primary neural networks operatively connectable to receive inputs associated with respective ones of the network functions, each of the primary neural networks having an output; and
a first tier of neural networks operatively connected to combine selected outputs of the primary neural networks.

2. A hierarchical neural network according to claim 1, wherein each of the first tier of neural networks has an output, and the neural network further comprises:
a second tier of neural networks operatively connected to combine selected outputs of the first tier of neural networks.

3. A hierarchical neural network according to claim 1, wherein at least some of the first tier of neural networks operate to combine selected outputs of the primary neural networks using a combinational logic function.

4. A hierarchical neural network according to claim 2, wherein at least some of the second tier of neural networks operate to combine selected outputs of the first tier neural networks using a combinational logic function.

5. A hierarchical neural network according to claim 1, wherein at least some of the first tier of neural networks operate to combine selected outputs of the primary neural networks using a combinational logic function.

6. A hierarchical neural network according to claim 3, wherein the combinational logic function includes at least one of a Soft OR and a Soft AND.

7. A hierarchical neural network according to claim 4, wherein the combinational logic function includes at least one of a Soft OR and a Soft AND.

8. A hierarchical neural network according to claim 5, wherein the combinational logic function includes at least one of a Soft OR and a Soft AND.

9. A method of detecting an anomaly using a hierarchical neural network, comprising:
applying signals representative of selected network functions to a primary set of neural networks;
applying selected outputs of at least some of the primary neural networks to first tier neural networks; and
using at least some of the outputs of the first tier neural networks to detect an anomaly.

10. A method of detecting an anomaly according to claim 9, wherein the applying selected outputs of at least some of the primary neural networks to first tier neural networks includes combining at least some of those outputs.

11. A method of detecting an anomaly according to claim 10, wherein the combining at least some of those outputs includes combining those outputs using a combinational logic function.

12. A method of detecting an anomaly according to claim 10, wherein the combining at least some of those outputs includes combining those outputs using at least one of a Soft OR and a Soft AND

13. A method of detecting an anomaly according to claim 11, wherein the combinational logic function includes at least one of a Soft OR and a Soft AND.
